(19) United States
(12) Patent Application Publication
(10) Pub. No.: US 2020/0301972 A1
(43) Pub. Date: Sep. 24, 2020

(54) GRAPH ANALYSIS OF TIME-SERIES CLUSTER DATA

(71) Applicant: eBay Inc., San Jose, CA (US)

(72) Inventors: Hanzhang Wang, Santa Clara, CA (US); Vinay Phegade, Cupertino, CA (US)

(21) Appl. No.: 16/360,417

(22) Filed: Mar. 21, 2019

(51) Int. Cl. G06F 16/901; G06N 20/10

(52) U.S. Cl. CPC G06F 16/9024; G06N 20/10

(57) ABSTRACT

Described are computing systems and methods as well as computer program products for enhancing the detection of abnormal online user behavior by incorporating time-series data of behavior-based user clusters into an entity graph for purposes of entity resolution. In various embodiments, graph analysis performed on a graph that includes nodes representing users, user attributes, and user clusters serves to determine groups of similar user entities, which may then be merged and/or further analyzed to detect abnormal behavior.

### TECHNICAL FIELD

The present disclosure relates to graph-based detection of abnormal usage of computer systems and online services, and in particular to user entity resolution.

### BACKGROUND

Online services, such as e-banking services, e-commerce platforms, social networking sites, media-streaming services, etc. may encounter a single actor as appearing to the service(s) as multiple different users (legitimately or illegitimately). Similarly, automated bots may act simultaneously towards a purpose; the hots may even be located in different regions. Fundamentally, this presents an entity-resolution problem: a problem is to automatically disambiguate users and detect when multiple user entities represent the same actual user.

### BRIEF DESCRIPTION OF THE DRAWINGS

The appended drawings illustrate, by way of example and not of limitation, various embodiments of systems, methods, and computer program products implementing the inventive subject matter.

FIG. 1 is a block diagram illustrating a computer ecosystem, according to some embodiments, in which misuse of online services can occur.

FIG. 2 is a block diagram illustrating components of a system for detecting abnormal user behaviors according to some embodiments.

FIG. 3 is a schematic diagram illustrating the creation of user clusters in accordance with sonic embodiments.

FIG. 4 is a table illustrating example time-series user clusters in accordance with some embodiments.

FIG. 5 is an example entity graph in accordance with some embodiments.

FIG. 6 is a flow chart of a method for graph-based entity resolution in accordance with some embodiments.

FIG. 7 is a flow chart of methods of further processing and using identified groups of similar users, in accordance with various embodiments.

FIG. 8 is a diagrammatic representation of a machine in the example form of a computer system within which a set of instructions for causing the machine to perform any one or more of the methodologies discussed herein may be executed.

### DETAILED DESCRIPTION

In the following description, reference will be made to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Described herein is an approach to detect abnormal online user activity that combines user clustering based on user behavioral data with entity graph analysis. In various embodiments, user activity logged by an online service is processed and/or aggregated across a series of time windows to obtain time-series user behavioral data, and a machine-learning clustering algorithm is applied to features extracted from the data to create a time series of user clusters. The user clusters are then incorporated into an entity graph whose nodes each represent a uniquely identified user entity (e.g., a user ID or account), a user cluster, or a user attribute such as, e.g., a user name, email address, phone number, address, or other piece of static information associated with a user. A graph algorithm can process the entity graph to identify groups of user nodes that are similar to each other in terms of their associated attributes and/or affiliation with user clusters. Based on the identified groups, and optionally following human confirmation of the groupings, user entities can be disambiguated (e.g., by merging user accounts that appear to belong to the same user); user behavior can be further analyzed, e.g., to detect anomalous activity of certain user groups or identify outliers that do not fall within any of the identified user clusters; and threats can be determined and managed based on the analysis. Feedback on the user groupings determined by the graph algorithm may be used to adjust the graph algorithm and/or the machine-learning or other algorithms employed in forming user clusters.

By combining the results of a machine-learning clustering algorithm applied to time series data with a graph of attributes, a technical advantage is conferred of improvement to the data accuracy of predictions of a user entity and/or user cluster. Because data accuracy is improved, this may also improve the performance and efficiency of machines dedicated to identification of accurate user entities or groups of user nodes. Yet another technical advantage is conferred by improving data accuracy of a user entity, because security and trust of a system is improved. Finally, by combining features of a graph and continuous machine learning on time series data, it allows for an adaptive system that scales and performs against different and changing environments.

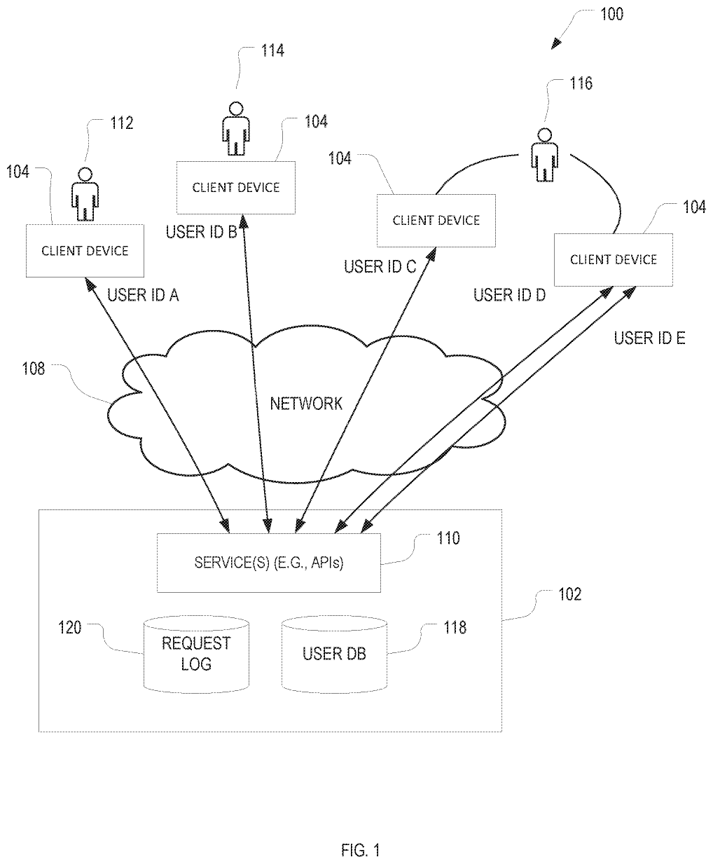

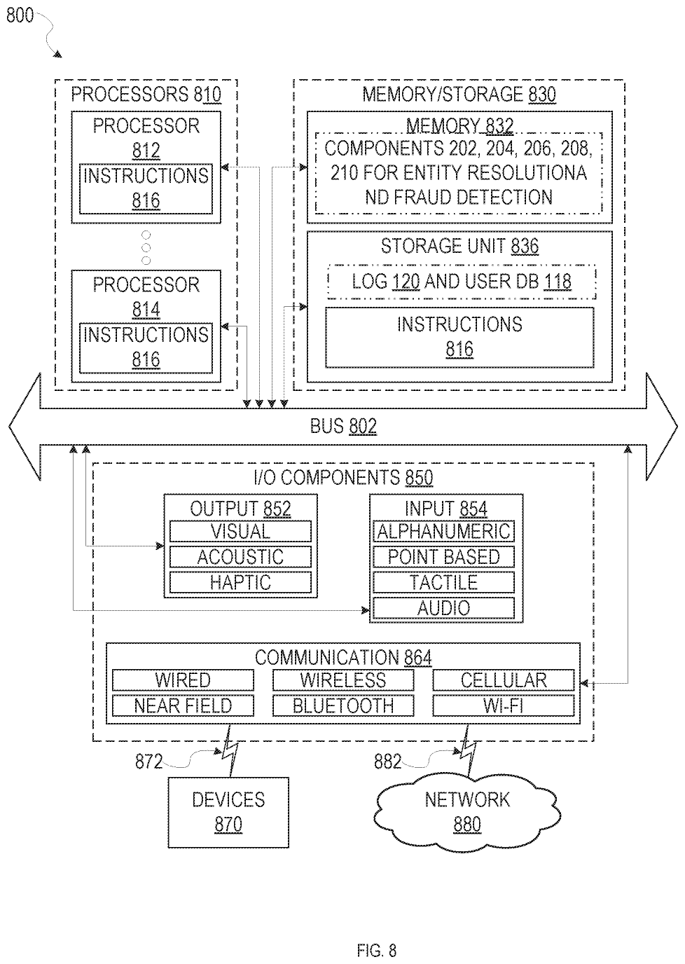

FIG. 1 is a block diagram illustrating a computer ecosystem 100, according to some embodiments, in which abnormal use of online services can occur. The ecosystem 100 includes a server 102 and client devices 104 that communicate with the server 102 via a communication network 108, which may be, for example and without limitation, the internet or another wide-area network (WAN). The server 102 and the client devices 104 are implemented by suitable computing hardware including one or more computer processors, which may generally include any combination of general-purpose processors configured by program code stored in computer-readable media to perform the functionality described herein and/or hardwired or otherwise permanently configured special-purpose processors. In various embodiments, the server 102 includes either a single server computer or multiple server computers communicating with each other via a suitable wired or wireless network, such as, for example and without limitation, a local area network (LAN) established by Ethernet cable or Wi-Fi connections between computers, or a WAN, such as the internet, utilizing telephone lines, radio wave transmission, or optical fiber connections. The client devices 104 may be personal computers, such as desktop or laptop computers, tablets, smartphones, or the like, although a cluster of networked computers may also play the role of a client device 104. The one or more computers of the server 102 and the client devices 104 may each be implemented, e.g., with a machine 800 as described in more detail below with reference to FIG. 8. To facilitate communications via the network 108, the server 102 and client devices 104 include suitable network interfaces.

The server 102 hosts one or more services 110, e.g., implemented as web services or application programming interfaces (APIs), that can be accessed by users 112, 114, 116 via their respective client devices 104. In accordance with various embodiments, requests from a user identify the user to the accessed service 110, e.g., via explicit user credentials (such as user name and/or password) or implicitly via a device identifier (such as the internet protocol (IP) address or media access control (MAC) address of the device) of the device utilized by the user, allowing the server 102 to recognize distinct user entities. In some embodiments, user entities are represented by user accounts established during a formal user registration process. In other embodiments, user entities are created indirectly based on a piece of information consistently obtained by the server 102 for each user session an email address or device identifier) and correlated across session. Whatever information is employed by the server 102 to distinguish between user entities constitutes, functionally, a user ID for purposes of the disclosed subject matter. In some embodiments, the server causes the user Ms to be stored in client-side cookies.

Apart from the user ID, the server 102 may collect additional static user information that at least partially identifies the user, but is not necessarily uniquely associated with a single user entity. Such additional static identifying information (herein also “user attributes”) may include, for instance, the user's email address, mailing address, and/or telephone number as obtained, e.g., during the user registration process, or a device identifier of the device through which the user accesses the server 102. As will be appreciated, addresses, phone numbers, and device identifiers, among other user attributes, usually differ between user entities, but may, in some instances, be shared between two or more users (e.g., users living in the same household) and can, thus, be associated with multiples user entities. The server 102 may maintain a user database 118 that stores the user attributes along with the user IDs. Furthermore, the server 102 may log user activity (in association with the respective user ID) in a request log 120. The logged information may include, e.g., click data (and associated URLs), text input (e.g., search queries), scroll-throughs and mouse-overs, other user actions, and/or data about content delivered to the user by the server 102 (e.g., search result listings), and may be extracted from the user requests (or associated responses provided by the server 102) and/or captured client-side (e.g., using suitable Java scripts) and communicated to the server 102. Collectively, the logged data provides insight into users' behavior vis-á-vis the service(s) 110.

The user entities recognized by the server 102 are generally presumed to map onto distinct actual users. For example, with reference to FIG. 1, users 112 and 114 correspond to the user entities represented by user ID A and user ID B, respectively. However, a server 102 may be susceptible to activity in which a single user deliberately sets up multiple user accounts or otherwise impersonates multiple users accessing the service(s) 110 through one or more client devise 104. For example, in FIG. 1, user 116 identifies himself by user ID C using one client device 104 and by user ID D or E using another client device. Users may also combine to jointly establish fake user entities. To curb the risk for duplicate accounts and fake user entities, the server 102 may employ various tests, such as validating user-provided addresses and phone numbers to ensure they exist. One of the goals of the disclosed subject matter is to disambiguate user entities associated with the same user, using user behavioral data in conjunction with user attributes to improve over conventional entity-resolution methods. The following figures detail system and methods implementing this approach.

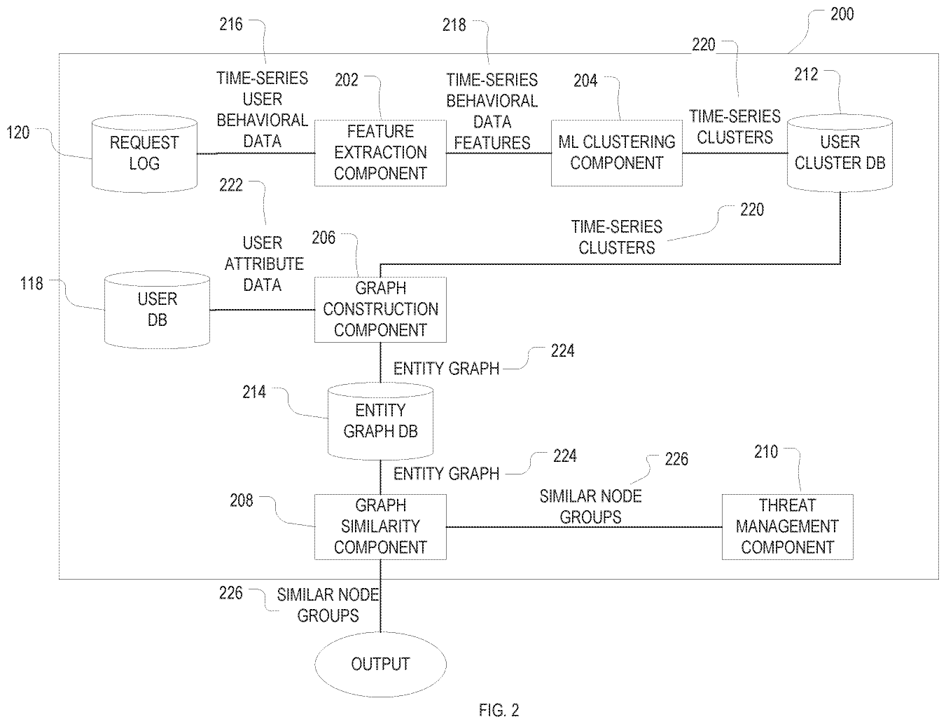

FIG. 2. is a block diagram illustrating components of an example computer system 200, e.g., as may be implemented by server 102 (and, more generally, by one or more computers, e.g., as shown in FIG. 8), for detecting abnormal user behaviors according to some embodiments. The system 200 includes multiple processing components, depicted as rectangles 202, 204, 206, 208, 210, that process and/or create various data structures, some of which may be stored in databases 120, 118, 212, 214. The various processing components may be implemented as sets of processor-executable instructions stored in one or more computer-readable media, and may run locally on the same computer or group of computers that hosts the service(s) 110 and stores the request log 120 and user database 118, or remotely by another computer or group of computers in communication with the request log 120 and database 118. For example, in some embodiments, the processing components form a software package available as a service (e.g., via the internet as a web service) to the operator of the service(s) 110.

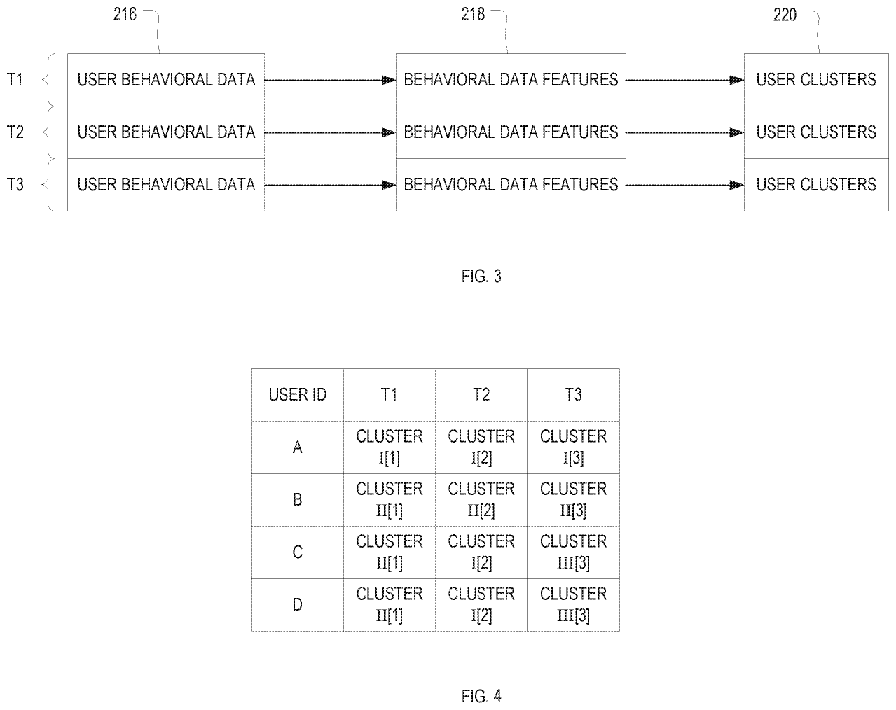

As shown, a feature extraction component 202 operates on time-series user behavioral data 216 obtained from a request log 120 (directly or indirectly by preprocessing raw log data retrieved from the request log 120). The extracted time-series behavioral data features 218 are fed into a machine-learning clustering component 204, which creates a time series of user clusters 220 that can be stored in a user cluster database 212. The clustering component 204 may employ any of various (generally unsupervised) machine-learning clustering algorithms known in the art, such as, e.g., K-Means, Expectation-Maximum (EM) algorithm, Hierarchical Clustering, or Competitive Learning. The creation of user clusters 220 based on user behavioral data 216 is explained in more detail below with reference to FIGS. 3 and 4.

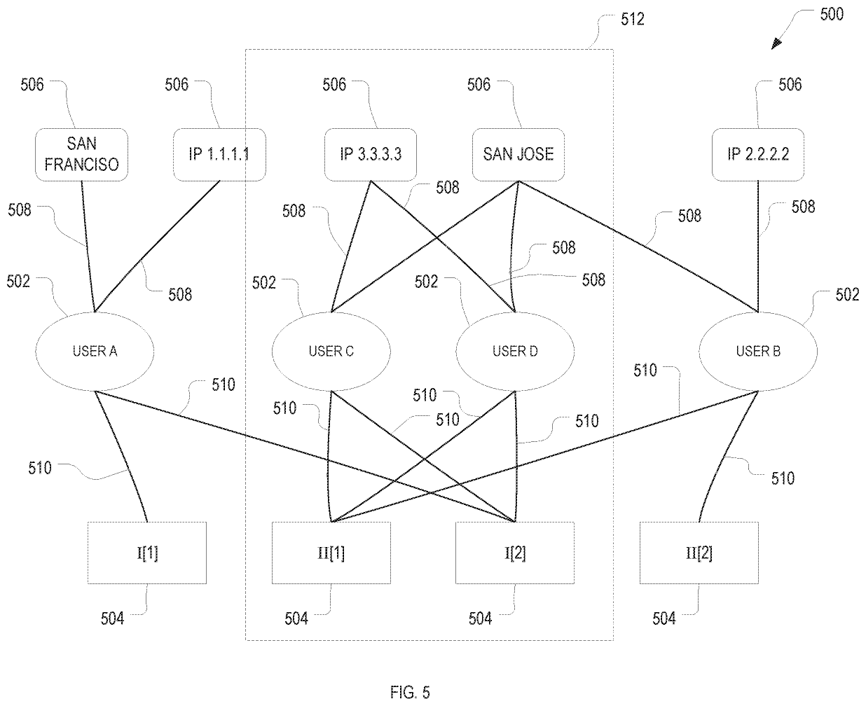

The time-series user clusters 220, which capture behavior-based user groupings as a function of time, and static (temporally unchanging) user attribute data 222 obtained a user database 118, are provided as input to a graph construction component 206, which reorganizes the data to create a data structure for an entity graph 224 that includes three types of nodes representing user entities, user attributes, and user clusters, respectively, as explained in more detail below with reference to an example entity graph shown in FIG. 5. The entity graph data structure 224 may be stored in an entity graph database 214, and may, for example, take the form of, or include, a binary matrix whose rows and columns correspond to the nodes, and whose entries represent edges between pairs of nodes (e.g., using a 1 for nodes that are connected to each other and a 0 everywhere else)

A graph similarity component 208 operates on the entity graph data structure 224 to identify groups 226 of user nodes that are similar in terms of their static user attributes and/or affiliation with the same user clusters over time. The user entities within a user group constitutes candidates of user entities belonging to the same user. Output 228 based on the identified similar node groups 226, such as a sub-graph of the entity graph 224 encompassing the similar nodes, may be provided to a human reviewer for verification that the user entities, indeed, belong to the same user. Alternatively or additionally, the identified similar node groups 226 may be provided as input to a threat management component 210, which may further analyze the user nodes within or outside the group to detect anomalous user behavior and take appropriate action to avert threats, e.g., by alerting a system administer, or blocking access to the system 200 for suspicious users.

Turning to FIG. 3, the creation of user clusters in accordance with some embodiments is illustrated in more detail. User clustering is based on a time series of user behavioral data 216, e.g., representing a sequence of user behavior associated with consecutive time periods (also “time windows”) T1, T2, T3, and so on. The user behavioral data 216 may result from pre-processing and aggregating logged user activity (as stored in the request log 120) over the time windows, for instance, daily, hourly, or per minute, depending, e.g., on the particular application context and average frequency of user action. Alternatively, the user behavioral data 216 may include the raw log data for the respective time windows. The user behavioral data 216 may be analyzed, separately for each time window (but in a consistent manner across time windows), to obtain a time series of behavioral data features 218. The behavioral data features 218 flow into a clustering process in which, again separately for each time window, clusters of user entities that behave similarly during the respective time period, are identified, collectively forming a time series of user clusters 220.

FIG. 4 is a table illustrating example time-series user clusters in accordance with some embodiments. The table stores for each user entity, represented by the respective user ID and corresponding to one of the rows in the table, the clusters to which the user entity belonged during each time window, where the time windows correspond to the columns in the table. The clusters are denoted by Roman numerals followed by the time window to which they belong indicated in brackets. (The indication of the time period serves to distinguish between clusters of different time periods that share the same Roman numeral. Note that the numbering of the clusters is arbitrary, and since the clusters generally change in time and are formed independently for each time window, clusters of different time windows that share the same Roman numeral need not bear any relation to one another.) In the illustrated example, during time window T1 (e.g., Oct. 6, 2018), user entity A forms its own single-node cluster I[1], and user entities B, C, and D fall into the same cluster II[1]. During time window T2 (e.g., Oct. 7, 2018), user entities A, C, and are all in one cluster I[2], and user entity B stands by itself in cluster II[2]. During time window T3, user entity A forms cluster I[3], user entity B forms cluster II[3], and user entities C and D form cluster III[3]. In general, as illustrated, the number of clusters can differ between time periods, and any cluster may include one or more user entities. The clusters may be disjunct, as shown, such that each user entity uniquely belongs to only one cluster during a given time period. Alternatively, at least for some clustering algorithms, user entities may be allowed to belong to simultaneously belong to multiple clusters, resulting in cluster overlap.

FIG. 5 is an example entity graph 500 in accordance with some embodiments, e.g., as may be created by graph construction component 206. The entity graph 500 combines time-dependent user cluster information (e.g., as illustrated in FIG. 4) with static user attributes, and includes three different types of nodes: user nodes 502 (indicated by ovals), cluster nodes 504 (indicated by sharp rectangles), and user-attribute nodes 506 (indicated by rounded rectangles). The user nodes 502 represent uniquely identified user entities, e.g., in the illustrated graph 500, user entities A, B, C, and D. The cluster nodes 504 each represent one of the clusters within the time series of user clusters. The user-attribute nodes 506 represent static identifying information associated with the users, e.g., as stored in and retrieved from the user database 118. In the depicted example, the user attributes include the city where the user lives and the IP address of the device the user uses. The entity graph 500 includes edges 508 between user-attribute nodes 506 and the user nodes 502 with which they are associated, as well as edges 510 between user nodes 502 and cluster nodes 504 for the user clusters to which they belong. For example, as shown, the user identified as user entity A lives in San Francisco and uses a device with IP address 1.1.1.1. The users identified as user entities B, C, and D all live in San Jose. User entity B has an associated IP address 2.2.2.2, and user entities C and D share IP address 2.2.2.2. Further, consistently with the example reflected in FIG. 4, user entity A belongs to user clusters I[1] and I[2]; user entity B belongs to user clusters II[1] and II[2], and user entities C and D both belong to clusters II[1] and I[2]. (Cluster information for T3 is omitted from the example graph 500.) Note that, while the entity graph 500 incorporates cluster information for a single time series, it is also possible to generate and incorporate multiple time series corresponding to user behaviors aggregated with different temporal granularity, e.g., a time series of hourly user clusters and a time series of daily user clusters (e.g., both covering the same overall timeframe)

The entity graph 500 is analyzed, in accordance herewith, to identify highly connected sub-graphs of user nodes 502 and associated user-attribute nodes 506 and cluster nodes 504, which indicate similarity between the user nodes within the sub-graph. For example, in FIG. 5, user nodes C and D both share the same set of user attribute nodes (IP 3.3.3.3 and San Jose) and cluster nodes (II[1] and I[2]), as represented by the sub-graph 512 indicated with a dashed frame. Thus, nodes C and D are very similar, which renders them candidates for user entities to be merged. Similarity between user nodes does not necessarily require them to share all user attributes and clusters, but may generally be based on a specified level of overlap between user attributes and user clusters, e.g., a certain number or fraction of shared attributes and clusters. To identify sub-graphs with similar use nodes, any of a number of graph-similarity algorithms known in the art may be employed. Suitable algorithms include, e.g., Jaccard Similarity, Cosine Similarity, Pearson Similarity, Euclidean Distance, and Overlap Similarity. The output of the graph similarity algorithm, which may be, e.g., one or more sub-graphs in their entirety or simply one or more groups of user nodes contained within the respective sub-graphs, can be displayed or fed into subsequent processing components for further analysis.

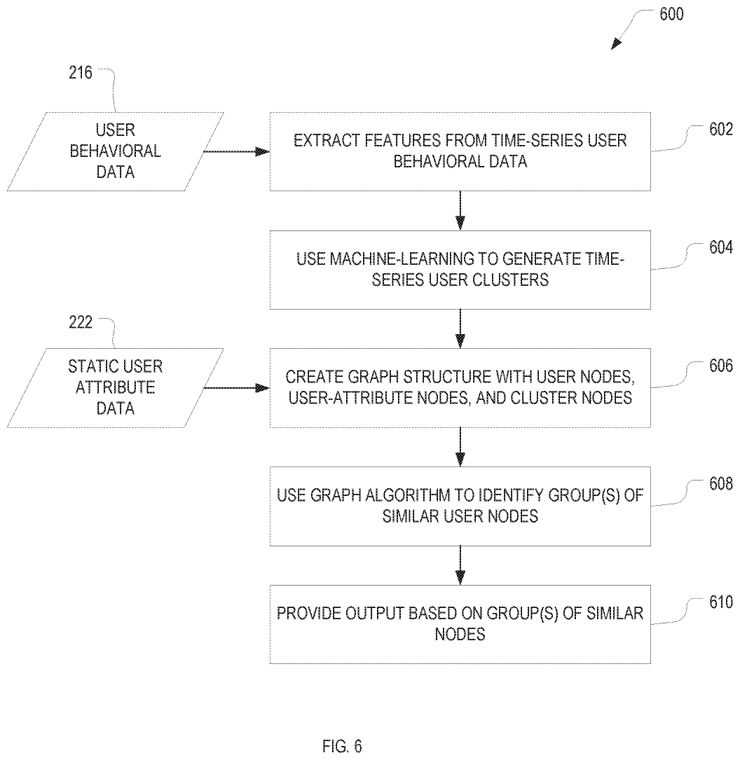

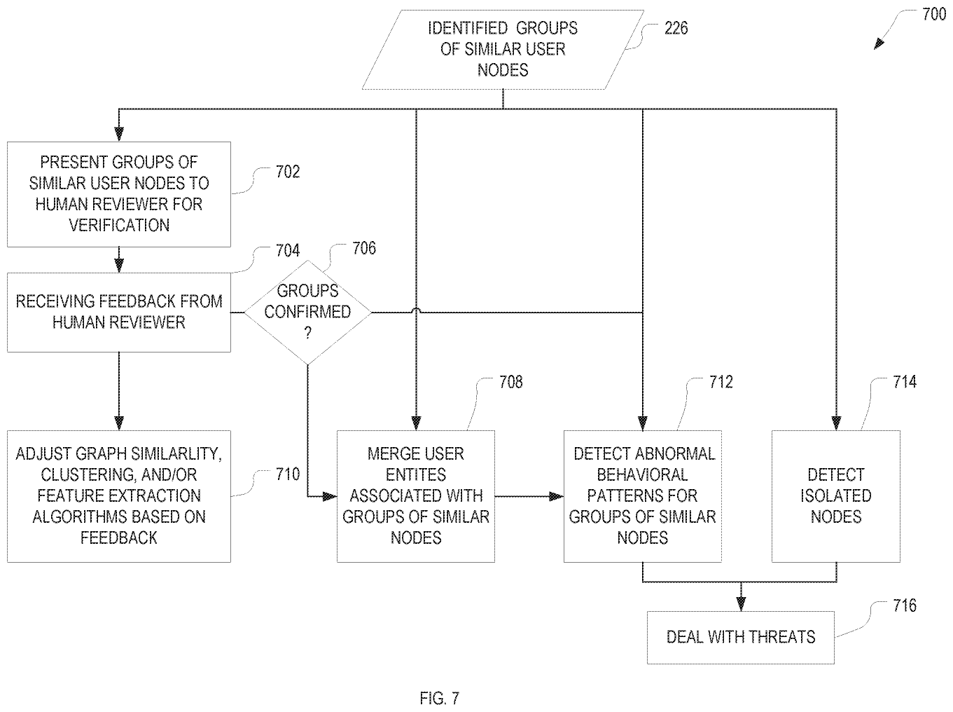

FIG. 6 illustrates, in the form of a flow chart, a method 600 for graph-based entity resolution in accordance with some embodiments, as may be performed, e.g., by the system 200 of FIG. 2. The method 600 involves extracting features from time-series user behavioral data 216 provided as input (operation 602), and using machine learning to cluster user entities for a sequence of time windows based on their associated behavioral data (operation 604). The user behavioral data may reflect the online activity of users represented by the user entities, and may include tracked and logged user interactions with online content (e.g., views, downloads, clicks, scroll-throughs, input into user-interface elements such as text-entry fields, radio selection buttons, audio input, and others). In some embodiments, the user behavioral data pertains to usage of an online service and may be extracted from requests received from the user of the online service and/or associated responses provided by the online service. User clusters formed based on behavioral data may reflect similar levels of activity and/or similar types and sequences of interactions of users within the cluster at a given time.

The method 600 further includes constructing, based on the time series of user clusters created in operation 604 in conjunction with static user attribute data 222 provided as an additional input, a graph structure that includes user nodes, user-attribute nodes, and cluster nodes (e.g., as described above with reference to FIG. 5) (operation 606). A graph algorithm is then employed, in act 608, to identify one or more groups of similar user nodes. Output that is based on the identified groups of similar nodes can be provided to a human or to downstream processing components (operation 610).

FIG, 7 is a flow chart illustrating methods 700 for further processing and using identified groups of similar users 226, in accordance with various embodiments, as may be performed, e.g., by the system 200 of FIG. 2. The methods 700 constitute multiple prongs some interdependencies) that can be performed individually or in parallel. In one prong, the identified groups similar user nodes 226 are presented to a human reviewer for verification (operation 702). For example, one or more sub-graphs of similar user nodes and associated attributes and clusters (such as, e.g., sub-graph 512 of FIG. 5) may be displayed to the reviewer in a suitable user interface. The sub-graph(s) visualize(s) in an intuitive manner the cause(s) of nodes being grouped together, which may include shared user attributes and/or shared clusters, and seeing the cause(s) may allow the reviewer to assess whether the user entities within the group can be assumed to belong to the same user, e.g., the same individual or a bot automatically accessing the system and posing as multiple human users. In some embodiments, the reviewer is given the opportunity to see the sub-graph within the context of the larger graph (or a portion thereof) and/or to drill down into the data associated with the graph, e.g., by listing all users within the clusters associated with the group of similar user nodes.

Based on feedback received from the reviewer in operation 704, further action may be taken. If the user confirms a particular grouping of user nodes (as determined at 706), the user entities within the group may be merged (operation 708). The confirmation may be partial, indicating that only some of the user entities should he merged, whereas others should be removed from the grouping. When user entities are determined to likely belong to the same actual user (and are therefore merged), this may be a signal of a system abuse, but may also be the result of legitimate or innocent accidental user action (e.g., a user opening a second account after forgetting about or being unable to access the first account, or multiple system-created user entities resulting from a user accessing a service with multiple devices). Merging user entities may inherently mitigate the potential for abuse and improve system operation by cleaning up unintentional duplicates.

Both affirmation and negation of the user-node grouping(s) by a human reviewer may be used by the system 200, in operation 710, to adjust the graph-similarity algorithm employed to identify groups of similar user nodes (as implemented by processing component 208) and/or, in some embodiments, the algorithms for feature extraction from the behavioral data and/or user clustering (as implemented by processing components 202, 204), e.g., by tweaking one or more adjustable parameters. In this manner, user feedback can serve to improve and enhance the entity-resolution process with supervised machine learning.

In another prong, the identified groups of similar user nodes 226, and the behavioral data associated with them, are further analyzed to detect abnormal behavioral patterns (operation 712). Further, apart from the user entities within the identified one or more groups of similar nodes, isolated nodes that fall outside of groups may be analyzed further (in operation 714). In this case, the threshold for grouping user nodes may be set lower, to capture normal behaviors engaged by many legitimate users (rather than detecting user entities associated with the same actual user), and deviation from such normal group behavior is taken as a trigger for further inquiry. Beneficially, by incorporating user behavioral data into entity graphs, it is possible to improve accuracy of user entity resolution.

Any detected abnormal behavior, whether engaged in by a group of similar user entities or a user entity associated with an isolated node in the entity graph, may be sent to a downstream processing component for further evaluation and determination of suitable remedial action (operation 716).

FIG. 8 shows a diagrammatic representation of a machine 800 in the example form of a computer system within which instructions 816 (e.g., software, a program, an application, an applet, an app, or other executable code) for causing the machine 800 to perform any one or more of the methodologies discussed herein may be executed. The machine 800 may, for example, implement any computer of the server 102 or system 200, or any of client devices 104. The instructions 816 may cause the machine 800 to execute any of the methods illustrated in the preceding figures. The instructions 816 transform the general, non-programmed machine into a particular machine programmed to carry out the described and illustrated functions in the manner described. By way of example only, dash-dotted boxes indicate the machine 800 as implementing the system 200.

In various embodiments, the machine 800 operates within a network through which it is connected to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, or other computer capable for use as any of the actors within the monitoring system described herein. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 812 and processor 814 that may execute instructions 816. The term “processor” is intended to include multi-core processor that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core process), multiple processors with a single core, multiple processors with multiples cores, or any combination thereof.

The memory/storage 830 may include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 may also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of processors 810 are examples of machine-readable media. When configured as the system 200, the memory 832 and/or storage unit 836 may, for instance, store the various processing components 202-210 for entity resolution, as well as the user database 118 and request log 120.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se. The terms “client” and “server” each refer to one or more computers—for example, a “server” may be a cluster of server machines.

The I/O components 850 may include a wide variety of components to receive input, provide output, produce output, transmit information, exchange information, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may. include output components 852 and input components 854. The output components 852 may include visual components (e.g., a display such as a plasma display panel (PDP), a light emitting diode (LEI)) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via coupling 882 and coupling 872 respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

The following numbered examples are illustrative embodiments of the disclosed subject matter.

1. A method comprising: performing, by one or more computer processors executing processor-readable instructions, operations comprising: extracting features from time-series user behavioral data; applying a machine-learning clustering algorithm to the extracted features to generate a time series of user clusters; creating a graph data structure for a graph comprising user nodes, cluster nodes, and user-attribute nodes, each user node representing a uniquely identified user entity, each cluster node representing one of the user clusters within the time series of user clusters, and each user-attribute node comprising static identifying information associated with one or more of the user entities, the graph comprising edges between user nodes and user-attribute nodes and between user nodes and cluster nodes; processing the graph data structure with a graph algorithm to identify one or more groups of similar user nodes; and providing an output based on the identified one or more groups of similar user nodes.

2. The method of example 1, wherein providing the output comprises displaying the identified one or more groups of similar user nodes, the operations further comprising receiving feedback indicating whether two user nodes within a same identified group of similar user nodes correspond a same user.

3. The method of example 2, the operations further comprising adjusting the graph algorithm based on the feedback.

4. The method of example 2 or example 3, the operations further comprising adjusting the machine-learning clustering algorithm based on the feedback.

5. The method of any of examples 1-4, the operations further comprising analyzing user behavioral data associated with user nodes within one of the identified one or more groups of similar user nodes to detect an abnormal behavioral pattern, the output comprising an indication of the abnormal behavioral pattern.

6. The method of any of examples 1-5, the operations further comprising detecting one or more user nodes isolated from the identified one or more groups of similar user nodes, the output comprising an indication of the one or more isolated user nodes.

7. The method of any of examples 1-6, the operations further comprising merging the user entities represented by the user nodes within a group of similar user nodes.

8. A server comprising: one or more hardware processors; and one or more computer-readable media storing instructions that cause the processor to perform operations comprising: extracting features from time-series user behavioral data; applying a machine-learning clustering algorithm to the extracted features to generate a time series of user clusters; creating a graph data structure for a graph comprising user nodes, cluster nodes, and user-attribute nodes, each user node representing a uniquely identified user entity, each cluster node representing one of the user clusters within the time series of user clusters, and each user-attribute node comprising static identifying information associated with one or more of the user entities, the graph comprising edges between user nodes and user-attribute nodes and between user nodes and cluster nodes; processing the graph data structure with a graph algorithm to identify one or more groups of similar user nodes; and providing an output based on the identified one or more groups of similar user nodes.

9. The system of example 8, wherein providing the output comprises displaying the identified one or more groups of similar user nodes, the operations further comprising receiving feedback indicating whether two user nodes within a same identified group of similar user nodes correspond a same user.

10. The system of example 9, the operations further comprising adjusting the graph algorithm based on the feedback.

11. The system of example 9 or example 10, the operations further comprising adjusting the machine-learning clustering algorithm based on the feedback.

12. The system of any one of examples claim 8-11, the operations further comprising analyzing user behavioral data associated with user nodes within one of the identified one or more groups of similar user nodes to detect an abnormal behavioral pattern, the output comprising an indication of the abnormal behavioral pattern.

13. The system of any one of examples claim 8-12, the operations further comprising detecting one or more user nodes isolated from the identified one or more groups of similar user nodes, the output comprising an indication of the one or more isolated user nodes.

14. The system of any one of examples claim 8-13, the operations further comprising merging the user entities represented by the user nodes within a group of similar user nodes.

15. One or more computer-readable media storing instruction which, when executed by one or more hardware processors of a machine, cause the machine to perform operations comprising: extracting features from time-series user behavioral data; applying a machine-learning clustering algorithm to the extracted features to generate a time series of user clusters; creating a graph data structure for a graph comprising user nodes, cluster nodes, and user-attribute nodes, each user node representing a uniquely identified user entity, each cluster node representing one of the user clusters within the time series of user clusters, and each user-attribute node comprising static identifying information associated with one or more of the user entities, the graph comprising edges between user nodes and user-attribute nodes and between user nodes and cluster nodes; processing the graph data structure with a graph algorithm to identify one or more groups of similar user nodes; and providing an output based on the identified one or more groups of similar user nodes.

16. The one or more computer-readable media of example 15, wherein providing the output comprises displaying the identified one or more groups of similar user nodes, the operations further comprising receiving feedback indicating whether two user nodes within a same identified group of similar user nodes correspond a same user.

17. The one or more computer-readable media of example 16, the operations further comprising adjusting the graph algorithm based on the feedback.

18. The one or more computer-readable media of any one of examples 15-17, the operations further comprising analyzing user behavioral data associated with user nodes within one of the identified one or more groups of similar user nodes to detect an abnormal behavioral pattern, the output comprising an indication of the abnormal behavioral pattern.

19. The one or more computer-readable media of any one of examples 15-18, the operations further comprising detecting one or more user nodes isolated from the identified one or more groups of similar user nodes, the output comprising an indication of the one or more isolated user nodes.

20. The one or more computer-readable media of any one of examples 15-19, the operations further comprising merging the user entities represented by the user nodes within a group of similar user nodes.

Although the inventive subject matter has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
performing, by one or more computer processors executing processor-readable instructions, operations comprising:
extracting features from time-series user behavioral data;
applying a machine-learning clustering algorithm to the extracted features to generate a time series of user clusters;
creating a graph data structure for a graph comprising user nodes, cluster nodes, and user-attribute nodes, each user node representing a uniquely identified user entity, each cluster node representing one of the user clusters within the time series of user clusters, and each user-attribute node comprising static identifying information associated with one or more of the user entities, the graph comprising edges between user nodes and user-attribute nodes and between user nodes and cluster nodes;
processing the graph data structure with a graph algorithm to identify one or more groups of similar user nodes; and
providing an output based on the identified one or more groups of similar user nodes.

2. The method of claim 1, wherein providing the output comprises displaying the identified one or more groups of similar user nodes, the operations further comprising receiving feedback indicating whether two user nodes within a same identified group of similar user nodes correspond a same user.

3. The method of claim 2, the operations further comprising adjusting the graph algorithm based on the feedback.

4. The method of claim 2, the operations further comprising adjusting the machine-learning clustering algorithm based on the feedback.

5. The method of claim 1, the operations further comprising analyzing user behavioral data associated with user nodes within one of the identified one or more groups of similar user nodes to detect an abnormal behavioral pattern, the output comprising an indication of the abnormal behavioral pattern.

6. The method of claim 1, the operations further comprising detecting one or more user nodes isolated from the identified one or more groups of similar user nodes, the output comprising an indication of the one or more isolated user nodes.

7. The method of claim 1, the operations further comprising merging the user entities represented by the user nodes within a group of similar user nodes.

8, A server comprising:
one or more hardware processors; and
one or more computer-readable media storing instructions that cause the processor perform operations comprising:
extracting features from time-series user behavioral data;
applying a machine-learning clustering algorithm to the extracted features to generate a time series of user clusters;
creating a graph data structure for a graph comprising user nodes, cluster nodes, and user-attribute nodes, each user node representing a uniquely identified user entity, each cluster node representing one of the user clusters within the time series of user clusters, and each user-attribute node comprising static identifying information associated with one or more of the user entities, the graph comprising edges between user nodes and user-attribute nodes and between user nodes and cluster nodes;
processing the graph data structure with a graph algorithm to identify one or more groups of similar user nodes; and
providing an output based on the identified one or more groups of similar user nodes.

9. The system of claim 8, wherein providing the output comprises displaying the identified one or more groups of similar user nodes, the operations further comprising receiving feedback indicating whether two user nodes within a same identified group of similar user nodes correspond a same user.

10. The system of claim 9, the operations further comprising adjusting the graph algorithm based on the feedback.

11. The system of claim 9, the operations further comprising adjusting the machine-learning clustering algorithm based on the feedback.

12. The system of claim 8, the operations further comprising analyzing user behavioral data associated with user nodes within one of the identified one or more groups of similar user nodes to detect an abnormal behavioral pattern, the output comprising an indication of the abnormal behavioral pattern.

13. The system of claim 8, the operations further comprising detecting one or more user nodes isolated from the identified one or more groups of similar user nodes, the output comprising an indication of the one or more isolated user nodes.

14. The system of claim 8, the operations further comprising merging the user entities represented by the user nodes within a group of similar user nodes.

15. One or more computer-readable media storing instruction which, when executed by one or more hardware processors of a machine, cause the machine to perform operations comprising:
extracting features from time-series user behavioral data;
applying a machine-learning clustering algorithm to the extracted features to generate a time series of user clusters;
creating a graph data structure for a graph comprising user nodes, cluster nodes, and user-attribute nodes, each user node representing a uniquely identified user entity, each cluster node representing one of the user clusters within the time series of user dusters, and each user-attribute node comprising static identifying information associated with one or more of the user entities, the graph comprising edges between user nodes and user-attribute nodes and between user nodes and cluster nodes;
processing the graph data structure with a graph algorithm to identify one or more groups of similar user nodes; and
providing an output based on the identified one or more groups of similar user nodes.

16. The one or more computer-readable media of claim 15, wherein providing the output comprises displaying the identified one or more groups of similar user nodes, the operations further comprising receiving feedback indicating whether two user nodes within a same identified group of similar user nodes correspond a same user.

17. The one or more computer-readable media of claim 16, the operations further comprising adjusting the graph algorithm based on the feedback.

18. The one or more computer-readable media of claim 15, the operations further comprising analyzing user behavioral data associated with user nodes within one of the identified one or more groups of similar user nodes to detect an abnormal behavioral pattern, the output comprising an indication of the abnormal behavioral pattern.

19. The one or more computer-readable media of claim 15, the operations further comprising detecting one or more user nodes isolated from the identified one or more groups of similar user nodes, the output comprising an indication of the one or more isolated user nodes.

20. The one or more computer-readable media of claim 15, the operations further comprising merging the user entities represented by the user nodes within a group of similar user nodes.
